(19) United States
(12) Patent Application Publication
(10) Pub. No.: US 2009/0006806 A1
(43) Pub. Date: Jan. 1, 2009

(54) Local Memory And Main Memory Management In A Data Processing System

(76) Inventor: Simon Ford, Cambridgeshire (GB)

Correspondence Address: NIXON & VANDERHYE, PC, 901 NORTH GLEBE ROAD, 11TH FLOOR, ARLINGTON, VA, 22203, US

(21) Appl. No.: 12/087,485

(22) PCT Filed: Mar. 29, 2006
(86) PCT No.: PCT/GB2006/001139

§ 371 Date: Jul. 8, 2008

(51) Int. Cl. G06F 12/06

(52) U.S. Cl. 711/210; 711/E12.084

(57) ABSTRACT

A data processing system (2) is provided including a local memory (4) and a main memory (6). The local memory (4) is accessed by a data engine (8) using local-memory physical addresses. The main memory (6) is accessed by a microprocessor (10) using main-memory addresses. A translation store (16) serves to store physical address TAGs indicating the mapping between data stored within the local memory (4) and corresponding data stored within the main memory (6). A coherency management mechanism (18) serves to use MESI coherency control data to manage the coherency between data values stored both in the local memory (4) and the main memory (6).

This invention relates to data processing systems. More particular, this invention relates to the management of a local memory and a main memory within a data processing system.

It is known to provide data processing systems with processing elements having local memory for improvement in speed/power/performance. One normal way of achieving this is to use a local RAM or TCM in the address map of the processing element. This approach has the advantage that the processing element concerned is able to directly access the local memory and accordingly there is advantageously little overhead associated with such accesses. However, a significant problem with this approach is that the data held in that local memory is normally a copy of the data in the main memory rather than a cache of that data. The main and local memories are visible in different parts of the address space, and data items are copied between them. This copy is usually explicitly controlled by a processing element in the system. This distributed memory model means there is generally nomechanism for providing coherency between the memories.

A cache memory provides an alternative model where data items within the local memory are cached copies of items in main memory. Data items in the local memory, usually arranged as cache lines, have corresponding address TAGs which are setup to indicate to which data items in main memory they correspond. The caching operation is usually occurs implicitly due to a memory request by a processing element. This may include allocation of a cache line, fetching the data, and setup of the TAGs. These TAGs enable various mechanisms to monitor the multiple copies of data items in the system and ensure coherency can be maintained. Within a multiprocessing environment, snooping can be used to ensure updates to one copy of the data are appropriately seen by other entities accessing that data. Whilst caches do address the problems of providing coherency, they bring with them some associated disadvantages.

The primary disadvantage is that the cache requires the TAGs to be accessed to determine if and where in the cache the data item exists. This cache TAG lookup consumes time and power compared to an access made directly to a RAM or TCM.

In addition, it may be desired to support virtual addressing. In this case, virtual to-physical address translation is required. This necessitates additional overhead in terms of circuit area and/or power consumption. In the case of physically addressed cache memory, an additional lookup is required prior to being able to access the cache.

Viewed from one aspect the present invention provides apparatus for processing data comprising:

a main memory having a main-memory address space;

a local memory having a local-memory physical address space;

processing logic coupled to said local memory and operable to output a physical address within said local-memory physical address space to said local memory to directly address a memory location within said local memory;

a translation store operable to store mapping data identifying a mapping between a plurality of regions of said local-memory physical address space and respective corresponding regions within said main-memory address space;

a local-memory control mechanism operable to transfer data between said main memory and said local memory and to maintain said mapping data; and

a coherency management mechanism responsive to said mapping data to manage coherence between data stored in corresponding regions of said local-memory physical address space and said main-memory address space.

The present technique can be considered to provide a reverse tagged local memory which is addressed using its own physical address space by the processing logic. More than one set of processing logic could share the local memory if properly coordinated. Since the local memory is directly addressed by the processing

element, no address translation or TAG lookup is required. In addition, mapping data is stored and maintained to provide a mapping of regions of the local memory to corresponding regions in the main memory such that coherency management can be performed. The local memory is flat mapped from the point of view of the processing logic enabling it to perform with a high degree of efficiency. Furthermore, the processing logic can control which data is moved into the local memory to suit a particular application or environment. Coherency management can be offloaded from the processing logic and dealt with elsewhere using the mapping data.

The present technique caches data by copying it into local address space, and setting up tags which can be used for coherency back to the main address space. Accesses to the local memory don't require a tag lookup, as it is known where the data was placed within the local memory. Coherency management mechanisms can still use the tags to ensure coherency with main or other memory (which can be physically addressed, virtually addressed or provide respective virtual address spaces for different programs being executed (e.g. use ASIDS)). This mechanism allows direct lookup in the local memory, in a manner similar to a RAM or TCM (i.e. with no tag lookup), but also provides coherency support in the same way as can be provided with caching mechanisms (the tags can be snooped). In the context of virtually addressed systems, the local address space can be virtually addressed since the processing logic has control over where data was placed in that local memory. The coherency tags can be populated with physical addresses which have been translated from virtual addresses for the purposes of coherency management. Local accesses to the local memory can use the virtual addresses and no address translation is required.

As will be appreciated, the coherency management mechanism is useful when further processing logic operates to access the main memory and accordingly will need coherency management to be performed between corresponding data in the main memory and the local memory.

The translation store can also be used to store coherency control data. Such coherency control data may, for example, be of a MESI protocol form.

Whilst the local memory and the main memory can vary in their capacity, it is normal for the main memory to have a greater capacity than the local memory.

The local memory controller will in preferred embodiments be responsive to one or more memory control instructions executed by the processing logic to copy data between the main memory and the local memory. Thus, software control of the data stored in the local memory is given to the processing logic.

The processing logic will typically perform data processing operations upon the data values stored within the local memory. The processing logic could be a data engine, a coprocessor, a general purpose microprocessor or some other data processing device.

In preferred embodiments, the local memory is configured as a plurality of local-memory lines with the regions within the local memory physical address space each corresponding to one or more local-memory lines.

The mapping data may typically be TAG data specifying respective main-memory physical address ranges corresponding to the regions of the local-memory physical address space mapped.

The local-memory control mechanism could take a variety of different forms such as, for example, a DMA unit, the processing logic operating under software control and/or a further processor operating under software control. In a similar way, the coherency management mechanism can take a variety of forms including a hardware unit snooping access to the main memory and the local memory, the processing logic operating under software control and/or a further processor operating under software control.

Viewed from another aspect the present invention provides a method of processing data using a main memory having a main-memory address space and a local memory having a local-memory physical address space; said method comprising the steps of:

outputting from processing logic a physical address within said local-memory physical address space to said local memory to directly address a memory location within said local memory;

storing mapping data identifying a mapping between a plurality of regions of said local-memory physical address space and respective corresponding regions within said main-memory address space;

transferring data between said main memory and said local memory and maintaining said mapping data; and

in dependence upon said mapping data, managing coherence between data stored in corresponding regions of said local-memory physical address space and said main-memory address space.

Viewed from a further aspect the present invention provides a computer program product comprising a computer readable medium storing a computer program executable by processing logic coupled to a main memory having a main memory address space and a local memory having a local memory physical address space to control the steps of:

outputting from said processing logic a physical address within said local-memory physical address space to said local memory to directly address a memory location within said local memory;

storing mapping data identifying a mapping between a plurality of regions of said local-memory physical address space and respective corresponding regions within said main-memory address space; and

transferring data between said main memory and said local memory and maintaining said mapping data.

Embodiments of the invention will now be described, by way of example only, with reference to the accompanying drawings in which:

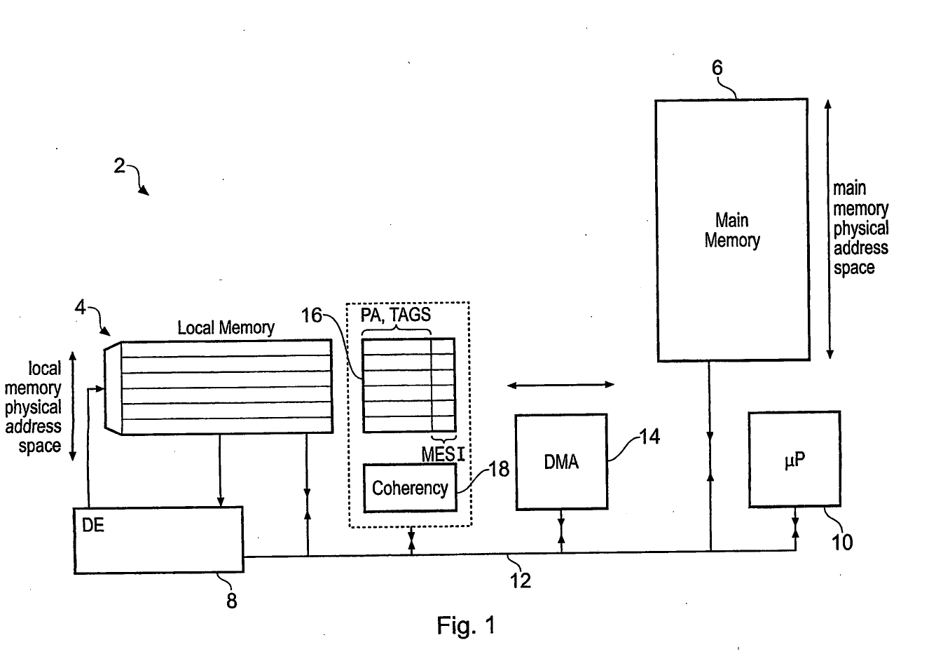

FIG. 1 schematically illustrates a data processing system including a local memory and a main memory together with a coherency management capability; and

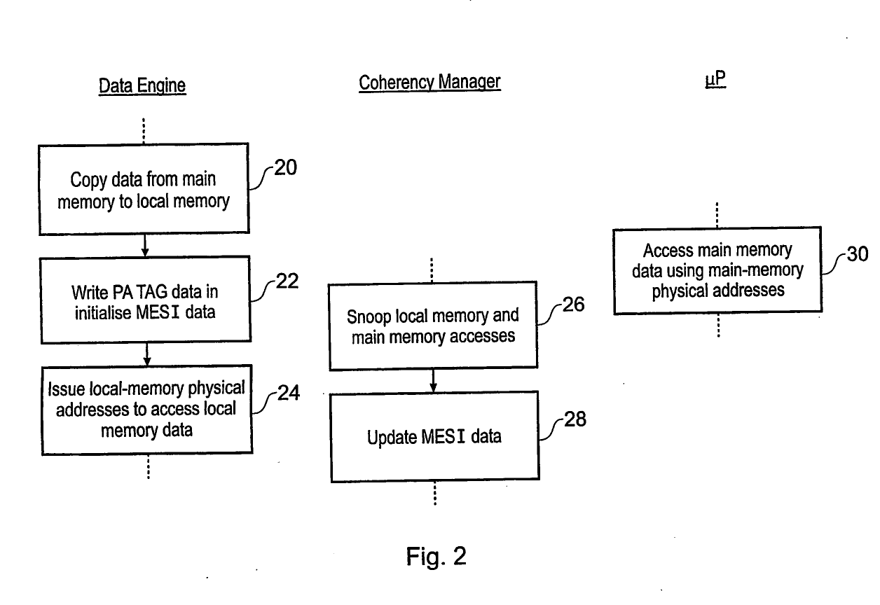

FIG. 2 schematically illustrates operations concerned with memory management which may be performed by different portions of the system illustrated in FIG. 1.

FIG. 1 shows a data processing system 2 including a local memory 4, a main memory 6, processing logic in the form of a data engine 8 and further processing logic in the form of a general purpose microprocessor 10. These elements 4, 6, 8, 10 are joined by a bus 12. Also connected to the bus 12 is a direct memory access (DMA) unit 14 to which may be delegated data copying operations such as copying data between the local memory 4 and the main memory 6. Also coupled to the bus 12 are a translation store 16 and a coherency management mechanism 18. The translation store 16 stores physical address TAG data for each of a plurality of regions within the local memory 4 together with coherency management data in the form of MESI data indicative of whether a particular region is storing data which is modified compared with corresponding data within the main memory 6, is available for shared access, is available for exclusive access or is invalid.

The main memory 6 in FIG. 1 has a physical address space and is physically mapped. In alternative embodiments the main memory 6 could be virtually addressed and/or provide multiple virtual address spaces for respective programs being executed (e.g. use ASIDs).

The data engine 8 executes program instructions (as part of its computer program) which trigger the DMA unit 14 to move data values from regions within the main memory 6 to specified regions within the local memory 4. At the same time, the physical address TAG data and coherency management data within the translation store 16 will be updated to reflect the mapping between the region of the local memory into which the data values have been copied and the corresponding region within the main memory together with the coherency management information. The updating of the TAG data and the MESI data may be performed by a separate program instruction(s) executed by the data engine 8 or may be automatically performed by dedicated hardware monitoring the transfers being performed. In this way, the data engine 8 may select data from within the main memory 6 and copy it into regions within the local memory 4. The data engine 8 when accessing that data within the local memory 4 uses local-memory physical addresses and considers the local memory to be a flat mapped physical address space which is directly accessible. This gives highly efficient access to the data within the local memory 4. Furthermore, the data engine 8 is able to control what data is present within the local memory 4 at any given time by copying that data into the local memory or copying it back to the main memory 6 (or simply invalidating it within the local memory 4 or overwriting it). More than one data engine could share the local memory 4 if desired and suitably co-ordinated.

As shown in FIG. 1, a microprocessor 10 serves as further processing logic which is operable to access data within the main memory 6 in response to execution of its own program instructions. Thus, the data processing system 2 is a multiprocessing system. Some of the data being accessed by the data engine 8 and the microprocessor 10 may be data which is shared and is present in both the local memory 4 and the main memory 6. The coherency management mechanism 18 serves to snoop bus transactions on the bus 12 to identify when the microprocessor 10 is accessing a data item within the main memory 6 which is indicated by the physical address TAGs within the translation store 16 to also be present within the local memory 4. When such an access is noted by the coherency management mechanism 18, the coherency control data MESI is updated according to the accesses and changes performed. This type of coherency control using MESI protocols is in itself known and will be familiar to those in this technical field.

The main memory 6 has a greater memory storage capacity than the local memory 4. The local memory 4 may be conveniently divided into equal size regions each corresponding to one line of data which is mapped by a physical address TAG to a corresponding line of data within the main memory 6. It will be appreciated that the regions within the local memory 4 could be divided in many different ways and could be multiple lines in length or could each vary in length. In the example discussed above, the local-memory control mechanism is provided by the data engine 8 acting in cooperation with the DMA unit 14. However, the local-memory control mechanism could be provided in other ways and with other combinations, such as including operation of a further processor within the system, e.g. the microprocessor 10. In a similar way, the coherency management mechanism 18 is described as a dedicated hardware element in the example embodiment of FIG. 1, but it will be appreciated that this coherency management 18 mechanism may be provided entirely or partially by software on the data engine 8, or on the microprocessor 10, or on some other further processor.

FIG. 2 schematically illustrates the operations being performed by different elements within the data processing system 2 of FIG. 1. At step 20, the data engine 8 executes one or more program instructions which command the DMA unit 14 to copy data from the main memory 6 to the local memory 4. At step 22, program instructions executed by the data engine 8 make corresponding entries and/or updates to the physical address TAGs within the translation store 16 as well as the corresponding coherency control data MESI. At step 24, the data engine 8 issues local-memory physical addresses to the local memory 4 so as to access data values stored within the local memory 4.

At step 26, the coherency management mechanism 18 snoops transactions on the bus 12 to identify accesses to the local memory 4 and the main memory 6. When these accesses are material to coherency management, then the coherency management mechanism 18 at step 28 updates the MESI data stored within the translation store 16 in association with the physical address TAGs.

At step 30, the microprocessor 10 accesses data values stored within the main memory 6 by issuing main memory physical addresses to the main memory 6.

1. Apparatus for processing data comprising:
a main memory having a main-memory address space;
a local memory having a local-memory physical address space;
processing logic coupled to said local memory and operable to output a physical address within said local-memory physical address space to said local memory to directly address a memory location within said local memory;
a translation store operable to store a plurality of mapping data each of said plurality of mapping data identifying a mapping between a region of said local-memory physical address space and a respective corresponding region within said main-memory address space;
a local-memory control mechanism operable to transfer data between said main memory and said local memory and to maintain said mapping data; and
a coherency management mechanism responsive to said mapping data to manage coherence between data stored in corresponding regions of said local-memory physical address space and said main-memory address space.

2. Apparatus as claimed in claim 1, wherein said main-memory address space is a main-memory physical address space.

3. Apparatus as claimed in claim 1, wherein said main-memory address space is a main-memory virtual address space.

4. Apparatus as claimed in claim 3, wherein said main-memory virtual address space provides a plurality of virtual address spaces associated with respective programs being executed.

5. Apparatus as claimed in claim 1, comprising further processing logic operable to access said main memory.

6. Apparatus as claimed in claim 1, wherein said translation store also stores coherency control data indicative of a coherency status of said plurality of regions of said local-memory physical address space and said respective corresponding regions within said main-memory address space.

7. Apparatus as claimed in claim 6, wherein said coherency control data comprises status data specifying for data within respective regions of said local-memory physical address space one or more of:
said data is modified compared with corresponding data within said main memory;
said data is available for shared access;
said data is available for exclusive access by said processing logic; and
said data is invalid.

8. Apparatus as claimed in claim 1, wherein said main memory has a greater memory capacity than said local memory.

9. Apparatus as claimed in claim 1, wherein said local-memory controller is responsive to one or memory control instructions executed by said processing logic to copy data between said main memory and said local memory.

10. Apparatus as claimed in claim 1, wherein data processing program instructions executed by said processing logic operate upon data values stored within said local memory.

11. Apparatus as claimed in claim 1, wherein said local memory comprises a plurality of local-memory lines and said regions within said local-memory physical address space each correspond to one or more local-memory lines.

12. Apparatus as claimed in claim 11, wherein said regions within said local-memory physical address space each correspond to one local-memory line.

13. Apparatus as claimed in claim 1, wherein said mapping data is TAG data specifying respective main-memory address ranges corresponding to said one or more regions of said local-memory physical address space.

14. Apparatus as claimed in claim 1, wherein said local-memory control mechanism comprises one or more of:
a DMA unit;
said processing logic operable under software control; and
a further processor operable under software control.

15. Apparatus as claimed in claim 1, wherein said coherency management mechanism comprises one or more of:
a hardware unit snooping access to said main memory and said local memory;
said processing logic operable under software control; and
a further processor operable under software control.

16. A method of processing data using a main memory having a main-memory address space and a local memory having a local-memory physical address space; said method comprising the steps of:
outputting from processing logic a physical address within said local-memory physical address space to said local memory to directly address a memory location within said local memory;
storing a plurality of mapping data each of said plurality of mapping data identifying a mapping between a region of said local-memory physical address space and a respective corresponding region within said main-memory address space;
transferring data between said main memory and said local memory and maintaining said mapping data; and
in dependence upon said mapping data, managing coherence between data stored in corresponding regions of said local-memory physical address space and said main-memory address space.

17. A method as claimed in claim 16, wherein said main-memory address space is a main-memory physical address space.

18. A method as claimed in claim 16, wherein said main-memory address space is a main-memory virtual address space.

19. A method as claimed in claim 18, wherein said main-memory virtual address space provides a plurality of virtual address spaces associated with respective programs being executed.

20. A method as claimed in claim 1, wherein further processing logic accesses said main memory.

21. A method as claimed in claim 16, further comprising storing coherency control data indicative of a coherency status of said plurality of regions of said local-memory physical address space and said respective corresponding regions within said main-memory address space.

22. A method as claimed in claim 21, wherein said coherency control data comprises status data specifying for data within respective regions of said local-memory physical address space one or more of:
said data is modified compared with corresponding data within said main memory;
said data is available for shared access;
said data is available for exclusive access by said processing logic; and
said data is invalid.

23. A method as claimed in claim 16, wherein said main memory has a greater memory capacity than said local memory.

24. A method as claimed in claim 16, wherein, in response to one or memory control instructions executed by said processing logic, copying data between said main memory and said local memory.

25. A method as claimed in claim 16, wherein, in response to data processing program instructions executed by said processing logic, performing data processing operations upon data values stored within said local memory.

26. A method as claimed in claim 16, wherein said local memory comprises a plurality of local-memory lines and said regions within said local-memory physical address space each correspond to one or more local-memory lines.

27. A method as claimed in claim 26, wherein said regions within said local-memory physical address space each correspond to one local-memory line.

28. A method as claimed in claim 16, wherein said mapping data is TAG data specifying respective main-memory physical address ranges corresponding to said one or more regions of said local-memory physical address space.

29. A method as claimed in claim 16, wherein said step of transferring data is performed by one or more of:
a DMA unit;
said processing logic operable under software control; and
a further processor operable under software control.

30. A method as claimed in claim 16, wherein said step of managing coherence is performed by one or more of:
a hardware unit snooping access to said main memory and said local memory;
said processing logic operable under software control; and
a further processor operable under software control.

31. A computer program product comprising a computer readable medium storing a computer program executable by processing logic coupled to a main memory having a main-memory address space and a local memory having a local-memory physical address space to control the steps of:
outputting from said processing logic a physical address within said local-memory physical address space to said local memory to directly address a memory location within said local memory;
storing a plurality of mapping data each of said plurality of mapping data identifying a mapping between a region of said local-memory physical address space and a respective corresponding region within said main-memory address space; and
transferring data between said main memory and said local memory and maintaining said mapping data.

32. A computer program product as claimed in claim 31, wherein said main-memory address space is a main-memory physical address space.

33. A computer program product as claimed in claim 31, wherein said main-memory address space is a main-memory virtual address space.

34. A computer program product as claimed in claim 33, wherein said main-memory virtual address space provides a plurality of virtual address spaces associated with respective programs being executed.

35. A computer program product as claimed in claim 31 wherein further processing logic accesses said main memory.

36. A computer program product as claimed in claim 31, wherein said computer program further controls storing coherency control data indicative of a coherency status of said plurality of regions of said local-memory physical address space and said respective corresponding regions within said main-memory address space.

37. A computer program product as claimed in claim 36, wherein said coherency control data comprises status data specifying for data within respective regions of said local-memory physical address space one or more of:
said data is modified compared with corresponding data within said main memory;
said data is available for shared access;
said data is available for exclusive access by said processing logic; and
said data is invalid.

38. A computer program product as claimed in claim 31, wherein said main memory has a greater memory capacity than said local memory.

39. A computer program product as claimed in claim 31, wherein said computer program includes one or memory control instructions which when executed by said processing logic copy data between said main memory and said local memory.

40. A computer program product as claimed in claim 31, wherein said computer program when executed by said processing logic performs data processing operations upon data values stored within said local memory.

41. A computer program product as claimed in claim 31, wherein said local memory comprises a plurality of local-memory lines and said regions within said local-memory physical address space each correspond to one or more local-memory lines.

42. A computer program product as claimed in claim 41, wherein said regions within said local-memory physical address space each correspond to one local-memory line.

43. A computer program product as claimed in claim 31, wherein said mapping data is TAG data specifying respective main-memory address ranges corresponding to said one or more regions of said local-memory physical address space.

44. A computer program product as claimed in claim 31, wherein said step of transferring data is performed by one or more of:
a DMA unit controlled by said processing logic;
said processing logic controlled by said computer program; and
a further processor controlled by said processing logic.

45. A computer program product as claimed in claim 31, wherein said processing logic is operable under control of said computer program and in dependence upon said mapping data to manage coherence between data stored in corresponding regions of said local-memory physical address space and said main-memory address space.
